(19) United States
(12) Patent Application Publication
(10) Pub. No.: US 2008/0262842 A1
(43) Pub. Date: Oct. 23, 2008

(54) PORTABLE COMPUTER WITH SPEECH RECOGNITION FUNCTION AND METHOD FOR PROCESSING SPEECH COMMAND THEREOF

(75) Inventors: Hung-Lung Liang, Taipei (TW); Po-Wei Chou, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/101,163

(22) Filed: Apr. 11, 2008

(30) Foreign Application Priority Data
Apr. 20, 2007 (TW) 96113979

(51) Int. Cl. G10L 15/04

(52) U.S. Cl. 704/251; 704/E15.005

(57) ABSTRACT

A portable computer with a speech recognition function and the method for processing a speech command thereof is disclosed. In the method of a speech command, the speech command has Y command character strings, wherein Y is a positive integer and which is greater than or equal to one. The method includes a step: providing a plurality of speech recognition databases and loading a corresponding speech recognition database responding to execute the X-th command string of the speech command, wherein X is a positive integer and is greater than or equal to one and is less than or equal to N. When the string corresponding to the X-th command character string is found in the loaded speech recognition database, an operation designated by the X-th command string is executed, and when X is not equal to Y, one is added to X.

### CROSS-REFERENCE TO RELATED APPLICATION

This application claims the priority benefit of Taiwan application serial no. 96113979, filed on Apr. 20, 2007. The entirety of the above-mentioned patent application is hereby incorporated by reference herein and made a part of this specification.

### BACKGROUND OF THE INVENTION

1. Field of the Invention

The invention relates to a technology for processing a speech command and, more particularly, to a technology for processing a speech command with multi-level databases.

2. Description of the Related Art

Along with the popularization of computer systems, users require more and more convenience in the usage of computers. Therefore, input devices of computer systems such as conventional keyboards, mice, remote controllers, etc., gradually develop toward a more human-based operation technology such as the speech input control. The key of the speech control is the recognition rate of speech commands.

Generally speaking, a speech recognition technology makes a recognition based on keywords of a speech commands and is a simpler and more efficient. The recognition rate is directly based on all keywords stored in a keyword database in the invention, and since only keywords in a particular scope need to be recognized, the recognition rate of the speech recognition technology can reach a certain level.

However, the conventional recognition rate of the speech recognition technology reduces as the number of keywords in a database increase. That is to say, when a user stores more keywords into a database, the time for comparing words of the system is longer, and the complexity of comparison is also increased, which makes accuracy relatively decreased.

### BRIEF SUMMARY OF THE INVENTION

The invention provides a method for processing a speech command to increase the recognition rate of the speech command.

In addition, the invention also provides a portable computer with a speech recognition function, which has preferred speech recognition efficiency.

The invention provides a method for processing a speech command, and the speech command includes Y command strings, wherein Y is a positive integer and is greater than or equal to one. The method includes providing a plurality of speech recognition databases and loading a corresponding speech recognition database responding to execute the X-th command string of the speech command, wherein X is a positive integer and is greater than or equal to one and is less than or equal to N. When a string corresponding to the X-th command string is found in the loaded speech recognition database, the operation designated by the X-th command string is executed, and one is added to X if X is not equal to Y.

In one embodiment, when no string corresponding to the X-th command string is found in the loaded speech recognition database, the speech command is not executed.

Seen in a different light, the invention also provides a portable computer with a speech recognition function, which includes an input unit, a storage unit and a processing unit. The input unit can be used to receive a speech command. The storage unit stores a plurality of speech recognition databases. The processing unit is coupled to the input unit and the storage unit. When the speech recognition function of the portable computer is started up and a speech command having N command strings is inputted from the input unit, the processing unit can load a corresponding speech recognition database from the storage unit responding to execute the X-th command string of the speech command and search whether the loaded speech recognition database has a string corresponding to the X-th command string. When the string corresponding to the X-th command string is found in the loaded speech recognition database, the operation designated by the X-th command string is executed. In addition, one is added to X when X is not equal to N, wherein N is a positive integer and is greater than or equal to one, and X is a positive integer and is greater than or equal to one and is less than or equal to N.

Since not all command strings are necessarily in the same database in the embodiment of the present invention, multi-level configuration is adopted. Therefore, the embodiment of the invention can increase the recognition rate of a speech command and the searching speed of a command string, further to increase the processing speed of the speech command.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a block diagram of a portable computer with a speech recognition function according to an embodiment of the invention.

FIG. 2 is a flow chart showing steps of a method for processing a speech command according to a preferred embodiment of the invention.

FIG. 3 is a schematic diagram showing the configuration of a database according to a preferred embodiment of the invention.

FIG. 4 is a flow chart showing comparison steps of command strings according to a preferred embodiment of the invention.

### DETAILED DESCRIPTION OF THE EMBODIMENTS

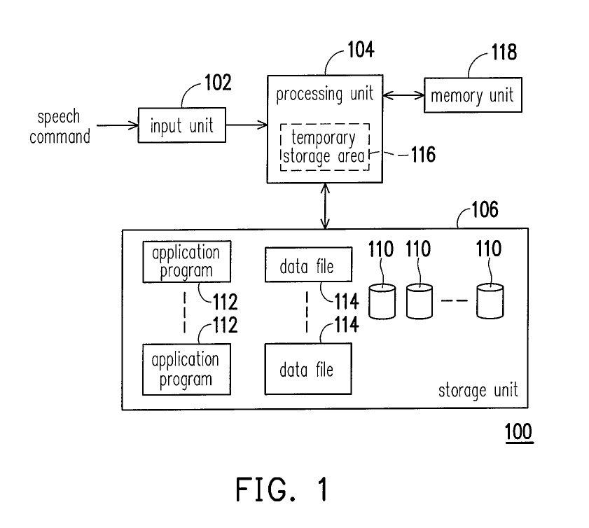

FIG. 1 is a block diagram of a portable computer with a speech recognition function according to an embodiment of the invention. Please refer to FIG. 1, in this embodiment, the portable computer 100 is a notebook or an ultra mobile personal computer (UMPC) system. The portable computer 100 includes an input unit 102, a processing unit 104, a storage unit 106 and a memory unit 118. The input unit 102 is electrically connected to the processing unit 104, and the processing unit 104 is electrically connected to the memory unit 118. The processing unit 104 is also electrically connected to the storage unit 106.

In the embodiment, the input unit 102 is a directional microphone and is assembled at the upper edge of a display of the portable computer 100 to preferably receive sounds, and after the input unit 102 receives an ambient sound, it outputs the received sound signal to the processing unit 104 coupled with the input unit 102. In other embodiments, the input unit 102 may be a common microphone. In the embodiment, the storage unit 106 is a hard disk drive and is coupled to the processing unit 104. In other embodiments, the storage unit 106 may be different storage devices, such as a memory card or SSD (solid state drives).

In the embodiment, the storage unit 106 stores a plurality of speech recognition databases 100. In addition, the storage unit 106 can further store a plurality of application programs 112 and a large quantity of data files 114.

Please go on referring to FIG. 1, and if a user wants to use a speech control function to operate the portable computer 100, an application program 112 stored in the storage unit 106 and be used to realize a speech recognition function should be started up first. If the speech recognition function of the portable computer 100 has been started up, the user can input a speech command to the portable computer 100 through the input unit 102. The user is allowed to input a speech command with a plurality of command strings in the embodiment of the invention, and each command string can also include a plurality of characters. In addition, characters of each command string need not necessarily to be the same in the embodiment of the invention.

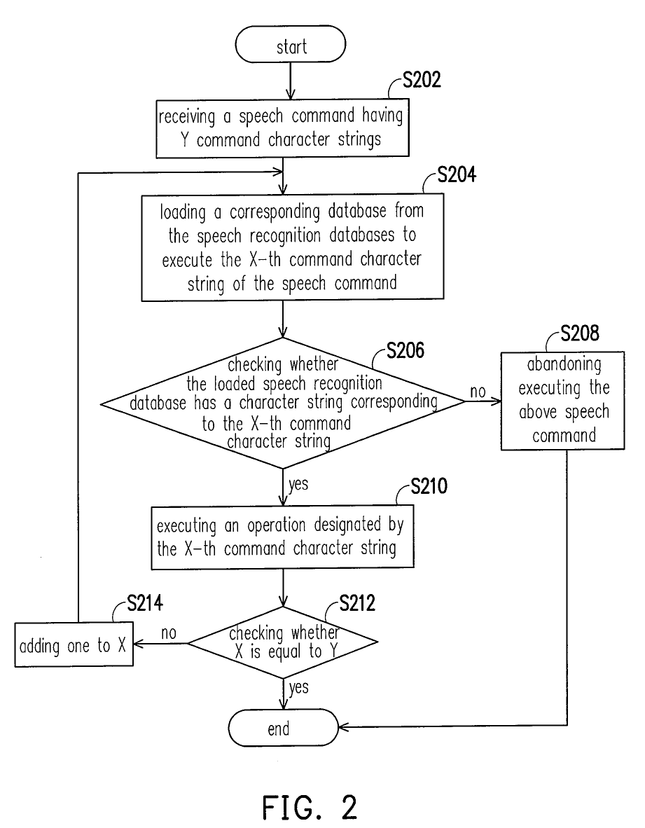

FIG. 2 is a flow chart showing steps of a processing method of a speech command according to a preferred embodiment of the invention. Please refer to FIGS. 1 and 2 simultaneously, and the following embodiment illustrates the spirit of the invention. If a user wants to use the portable computer 100 in the embodiment of the invention to play a song whose name is DDD of a singer whose name is AAA, the user can, as stated in step S202, input a speech command having Y command strings through the input unit 102 of the portable computer 100. Y is a positive inter and is greater than or equal to one. For example, the user says a speech command “Play AAA DDDD”, and then the speech command has three command strings “play”, “AAA”, “DDDD”, that is to say, Y is equal to three.

When the speech command is inputted to the portable computer 100 through the input unit 102, as stated in step S204, the processing unit 104 loads a corresponding speech recognition database 110 from the storage unit 106 responding to execute the X-th command string of the inputted speech command, wherein X is a positive integer and is greater than or equal to one and is less than or equal to Y.

For example, if X is one, the processing unit 104 processes the command string “play”. Therefore, the processing unit 104 can load a speech recognition database corresponding to the command string “play” from the storage unit 106 to execute the first command string.

Generally speaking, the processing unit 104 can have a temporary storage area 116 in which the loaded speech recognition database 110 can be stored. In other embodiments, the processing unit 104 can also make the loaded speech recognition database 110 stored in an external memory unit 118 such as a dynamic random access memory, which cannot affect the main spirit of the invention.

After the processing unit 104 loads the corresponding speech recognition database 110 from the storage unit 106, as stated in step S206, the processing unit 104 determines whether the loaded speech recognition database 110 has a string corresponding to the X-th command string. If the corresponding string is not found in the loaded speech recognition database 110 (“no” in step S206), that is to say, the speech command may be an invalid speech command or the speech command said (inputted) by the user is unclear. At this time, step S208 is executed in the embodiment, which is to abandon executing the inputted speech command.

Accordingly, if the processing unit 104 finds the string corresponding to the X-th command string in the loaded speech recognition database 110 (“yes” in step S206), as stated in step S210, the operation designated by the X-th command string is executed. If the processing unit 104 finds the command string “play” in the loaded speech recognition database 110, it starts up a multimedia play application program 112 stored in the storage unit 106 to prepare for playing a song.

On the other hand, as stated in step S212, in the embodiment, determining whether X is equal to Y can be done. In the embodiment, Y is three, and X is one at this time, and therefore, X is unequal to Y (“no” in step S212), and then step S214 is executed, that is to say, X is added by one, and steps such as the step S204, etc., are repeatedly executed.

In addition, the operation designated by the X-th command string, which is executed by the processing unit 104, is not necessary executing an application program in the embodiment of the present invention. If X equals to three in step S206, it is to search a song whose name is “DDDD” in the loaded speech recognition database. If the string corresponding to “DDDD” is found in the loaded speech recognition database, the processing unit 104 accesses the data file 114 of the song whose name is “DDDD” for the storage unit 106 (step S210). Since X is equal to Y (“yes” in step S212), the whole flow chart in FIG. 2 is terminated.

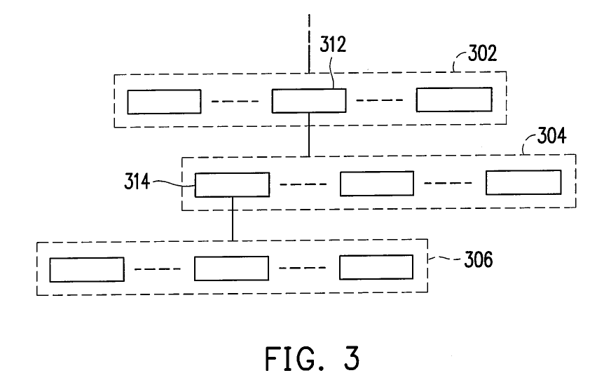

FIG. 3 is a schematic diagram showing the configuration of the databases. Please refer to FIG. 3, which shows speech recognition databases 302, 304 and 306 of different levels. First, in the preferred embodiment of the invention, a higher level speech recognition database 302 can be searched for a corresponding string first to execute a speech command. Taking the above embodiment to illustrate, supposing that a string 312 denotes the command string of above “play”, when the string 312 is found, not only the operation (such as starting up a media player) designated by the string 312 can be executed, but also the next lower level speech recognition database 304 can be called and loaded.

Supposing that the speech recognition database 304 includes all singers' names, in the preferred embodiment of the invention, after the operation designated by the string 312 has been executed, going on searching whether there is a string corresponding to “AAA” which is the name of the singer can be done. If a string 314 is the corresponding string, in the embodiment of the present invention, a speech recognition database 306 such as the list of all songs of the singer can be called according to the string 314. In this way, the user can utilize the portable computer 100 to properly execute the operation “play the song whose name is DDDD of the singer whose name is AAA”.

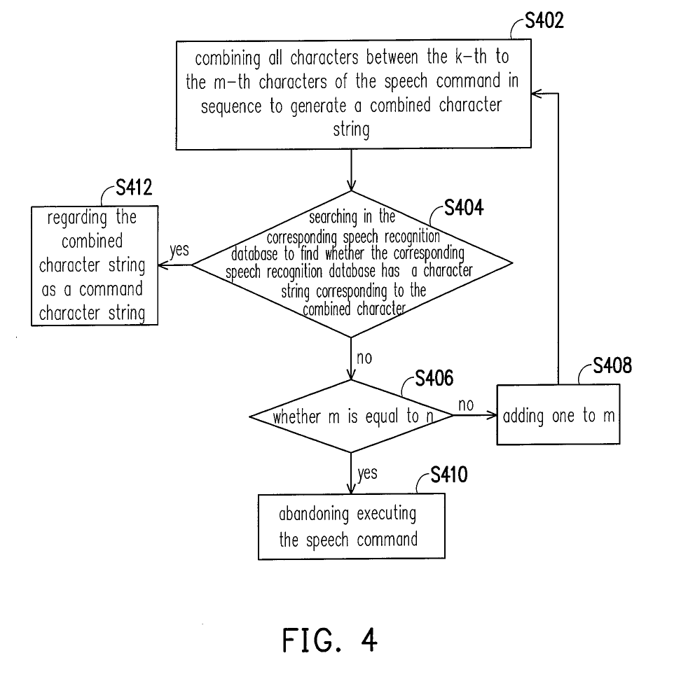

FIG. 4 is a flow chart showing comparison steps of command strings according to a preferred embodiment of the invention. Please refer to FIG. 4, in the embodiment as stated above, when comparing whether there is a corresponding string is done in the loaded speech recognition database, as stated in step S402, all characters between the k-th to the m-th characters of the speech command can be combined in sequence to generate a combined string. If the speech command has n characters, k is a positive integer and is greater than or equal to one and is less than m, and m is a positive integer which is greater than k and is less than or equal to n, and n is a positive integer which is greater than one.

Taking the above embodiment as an example, if in the embodiment, a string corresponding to “AAA” is searched in the loaded speech recognition database. At this time, k is set to be three, and the initial value of m is set to be four, and therefore, the generated combined string is “AA”. Next, in the embodiment, as stated in step S404, a string corresponding to the combined string is searched in the loaded speech recognition database.

If the loaded speech recognition database does not have a string corresponding to “AA” (“no” in step S404), as stated in step S406, whether m is equal to n is determined in the embodiment. Taking the above as an example, the speech command has nine characters, that is to say, n is equal to nine. Therefore, m is unequal to n (“no” in step S406), and step S408 is executed, that is, one is added to m, and m is five now. On the contrary, if m is equal to n (“yes” in step S406), as stated in step S410, abandoning executing the speech command is done.

Returning to step S408, since the newest value of m is five, a new generated combined string is “AAA”. Then, the step S404 is repeated. At this time, if a string corresponding to “AAA” is found in the loaded speech recognition database (“yes” in step S404), as stated in step S412, the combined string is regarded as a command string.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for processing a speech command, the speech command comprising Y command strings wherein Y is a positive integer and is greater than or equal to one, the method comprising:
providing a plurality of speech recognition databases;
loading a corresponding database from the speech recognition databases responding to execute an X-th command string of the speech command, wherein X is a positive integer and is greater than or equal to one and is less than or equal to Y;
determining whether the loaded speech recognition database has a string corresponding to the X-th command string;
executing an operation designated by the X-th command string when the string corresponding to the X-th command string is found in the loaded speech recognition database; and
adding one to X when X is unequal to Y.

2. The method according to claim 1, wherein the method is terminated when X is equal to Y.

3. The method according to claim 1, wherein when the loaded speech recognition database does not have a string corresponding to the X-th command string, the executing of the speech command is abandoned.

4. The method according to claim 1, wherein the speech command comprises n characters, and n is a positive integer.

5. The method according to claim 4, wherein the step of determining whether the loaded speech recognition database has a string corresponding to the X-th command string comprises:
combining all characters between the k-th to the m-th characters of the speech command in sequence to generate a combined string, wherein k is a positive integer and is greater than or equal to one and is less than m, and m is a positive integer and is greater than k and is less than or equal to n;
searching whether the corresponding speech recognition database has a string corresponding to the combined string in the corresponding speech recognition database;
regarding the combined string as the X-th command string when the string corresponding to the combined string is found in the corresponding speech recognition database;
determining whether m is equal to n when the string corresponding to the combined string is not found in the corresponding speech recognition database;
adding one to m when m is not equal to n, and regenerating the combined string; and
abandoning executing of the speech command when m is equal to n.

6. The method according to claim 1, wherein executing the operation designated by the X-th command string comprises one of executing an application program and accessing a data file.

7. The method according to claim 1 further comprising checking determining whether a speech recognition function is started up.

8. A portable computer with a speech recognition function comprising:
an input unit for receiving a speech command;
a storage unit storing a plurality of speech recognition databases; and
a processing unit coupled to the input unit and the storage unit,
wherein when the speech recognition function is started up and a speech command having N command strings is inputted from the input unit, the processing unit loads a corresponding speech recognition database from the storage unit responding to execute an X-th command string of the speech command and searches whether the corresponding speech recognition database has a string corresponding to the X-th command string in the corresponding speech recognition database, and when the string corresponding to the X-th command string is found in the loaded speech recognition database, the operation designated by the X-th command string is executed, and one is added to X when X is not equal to N, and N is a positive integer and is greater than or equal to one, and X is a positive integer and is greater than or equal to one and is less than or equal to N.

9. The portable computer according to claim 8, wherein the input unit is a directional microphone.

10. The portable computer according to claim 8, wherein the storage unit is a hard disk drive.

11. The portable computer according to claim 8, wherein the processing unit comprises a temporary storage area for storing the loaded speech recognition databases.

12. The portable computer according to claim 8 further comprising a memory unit coupled to the processing unit and be used to store the speech recognition databases.

13. The portable computer according to claim 12, wherein the memory unit is a dynamic random access memory.

14. The portable computer according to claim 8, wherein the processing unit executes an application program stored in the storage unit according to the X-th command string.

15. The portable computer according to claim 8, wherein the processing unit executes an operation that accesses a data file for the storage unit according to the X-th command string.
